(19) United States
(12) Patent Application Publication
(10) Pub. No.: US 2004/0035405 A1
(43) Pub. Date: Feb. 26, 2004

(54) Mixture adaptation method

(76) Inventors: Jens Wagner, Stuttgart (DE); Peter Kaltenbrunn, Bietigheim-Bissingen (DE)

Correspondence Address: KENYON & KENYON, ONE BROADWAY, NEW YORK, NY, 10004, US

(21) Appl. No.: 10/363,122

(22) PCT Filed: Aug. 23, 2001
(86) PCT No.: PCT/DE01/03227

(30) Foreign Application Priority Data
Sep. 2, 2000 (DE) 100 43 256.5

(51) Int. Cl. F02D 41/14

(52) U.S. Cl. 123/674; 123/689

(57) ABSTRACT

A method is introduced for compensating for mismatches of the precontrol of a fuel metering for an internal combustion engine[,].A [−a] regulation being superimposed on the precontrol[,].At [− and at] least one correction quantity being formed, from the behavior of the regulation at high temperatures of the internal combustion engine, which influences the fuel metering even at low temperatures of the internal combustion engine in a supplementing [way] manner to the superimposed regulation for compensating for the mismatches[, and − at] At low temperatures a further correction quantity is formed which acts upon the fuel metering, and [−] whose effect at low temperatures of the internal combustion engine is greater than at high temperatures.

### FIELD OF THE INVENTION

The present invention relates to a method and an electronic control device for compensating for mismatches of the precontrol of a fuel metering for an internal combustion engine.

### BACKGROUND INFORMATION

In the regulation of fuel/air ratios for internal combustion engines, [it is known that one may superimpose] a regulation may be superimposed on precontrol. [It is also known that one may derive further] Further correction quantities may be derived from the behavior of the regulated quantity, in order to compensate for mismatches of the precontrol to changed operating conditions. This compensation is also called adaptation. U.S. Pat. No. 4,584,982, for example, [describes] discusses an adaptation having different adaptation quantities in different ranges of the load/speed spectrum of an internal combustion engine. The various adaptation quantities are directed towards the compensation of different errors. With respect to cause and effect, three types of error may be distinguished: Errors of a hot film air mass meter have a multiplicative effect on fuel metering. Unmetered air influences have an additive effect per time unit, and errors in the compensation of the response delay of the fuel injectors have an additive effect per injection.

It has been shown that, even at complete adaptation in the hot state, mismatches at low engine temperatures continue to appear, which disappear again at higher temperatures.

### SUMMARY OF THE INVENTION

The present invention [is directed at compensating] provides for compensation for the temperature-conditioned mismatches, which are not observable when the engine is hot.

[This effect is attained using the features of claim 1.]

In particular, according to the present invention, a compensation of mismatches of precontrol of fuel metering in an internal combustion engine [takes place,] occurs, such that:

a regulation being superimposed on the precontrol,

[and] at least one correction quantity being formed, from the behavior of the regulation at high temperatures of the internal combustion engine, which influences the fuel metering even at low temperatures of the internal combustion engine in a complementing [way] manner to the superimposed regulation for the compensation of the mismatches, and

[and,] at low temperatures, [−]a further correction quantity being formed which has an effect upon the fuel metering in such a manner [way−] that its effect at lower temperatures of the internal combustion engine is greater than at high temperatures of the internal combustion engine.

A further measure provides that, for the formation of a further additional correction quantity (frat), the deviation of an average regulating controlled variable frm from the value 1 at comparably low engine temperatures T is integrated.

In another [specific] exemplary embodiment of the present invention, the integration at engine temperatures T is [carried out] performed over a temperature interval TMN<T<TMX.

According to [still] another [specific] exemplary embodiment, TMN as the lower interval limit amounts to 10-30° C., especially 20° C., and TMX as the upper interval limit corresponds to that temperature at which the usual adaptation is activated.

According to still another [specific] exemplary embodiment, TMX is approximately 70° C.

A further [specific] exemplary embodiment provides that the one further correction quantity, which acts upon the fuel metering in such a [way] manner that its effect at low temperatures of the internal combustion engine is greater than at high temperatures of the internal combustion engine, is changed as a function of the engine temperature in such a [way] manner that, at high temperatures, no differences from the [known] adaptation in a hot engine [come about] occur.

According to one additional [specific] exemplary embodiment, the output frak of the integrator is linked to a temperature-dependent quantity ftk in such a [way] manner that the result of the linkage decreases with increasing temperature.

Then, according to another [specific] exemplary embodiment, the temperature-dependent quantity ftk [can] may form a multiplicative correction varying between zero and one, the value zero [coming about] occuring when the engine is hot.

The correction [can] may vary continuously between these extreme values.

According to one further [specific] exemplary embodiment, the integration speed [can] may be dependent upon the values for the load and the speed of the engine.

[The] Also, the present invention [is also directed to] provides an electronic control device for [carrying out] performing the [methods] method and [specific] exemplary embodiments described above.

According to the present invention, the use of a further temperature-dependent adaptation quantity compensates for the above-mentioned mismatch of the precontrol at low engine temperatures. [This is particularly advantageous so as to make possible, in] In the diagnosis of a secondary air system, which is [preferably] active at low engine temperatures, a certain statement may be made concerning the secondary air mass flow. Besides that, the compensation for the temperature-dependent error relieves the lambda regulation at subsequent cold starts.

If the normal mixture adaptation is active at a high engine temperature, it learns, among other things, the density of the fuel. At a low temperature, the fuel has a greater density than at high temperature, and thus, the precontrol at high temperatures is no longer correct. The present invention [removes this disadvantage by] provides for the additional adaptation of the precontrol at low temperature.

[One exemplary embodiment of the present invention is shown below, with reference to the drawings.]

### BRIEF DESCRIPTION OF THE DRAWINGS

FIG. 1 shows the technical environment of the present invention.

FIG. 2 makes clearer the formation of a fuel metering signal on the basis of the signals from FIG. 1[, and].

FIG. 3 [describes] shows the development of an intervention, according to the present invention, in the formation of the fuel metering signal in the form of function blocks as the exemplary embodiment of the present invention.

### DETAILED DESCRIPTION

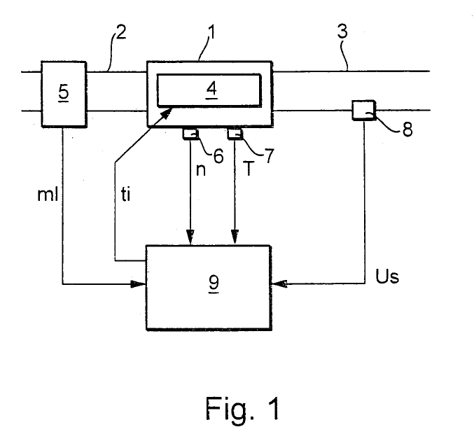

The number 1 in FIG. 1 represents an internal combustion engine [having] including an intake manifold 2, an exhaust pipe 3, a fuel metering [means] arrangement 4, sensors 5-8 for operating parameters of the engine and a control unit 9. The fuel metering [means] arrangement 4 may, for example, be made up of an arrangement of fuel injectors for the direct injection of fuel into the combustion chambers of the internal combustion engine.

Sensor 5 supplies a signal to the control unit concerning the air mass ml aspirated by the engine. Sensor 6 supplies an engine speed signal n. Sensor 7 makes available the engine temperature T, and sensor 8 supplies a signal Us concerning the exhaust gas composition of the engine. From these signals, and other signals, if necessary, regarding additional operating parameters of the engine, the control unit, besides additional controlled variables, forms fuel metering signal ti for controlling fuel metering [means] arrangement 4 in such a [way] manner that a desired behavior of the engine sets in, especially a desired exhaust gas composition.

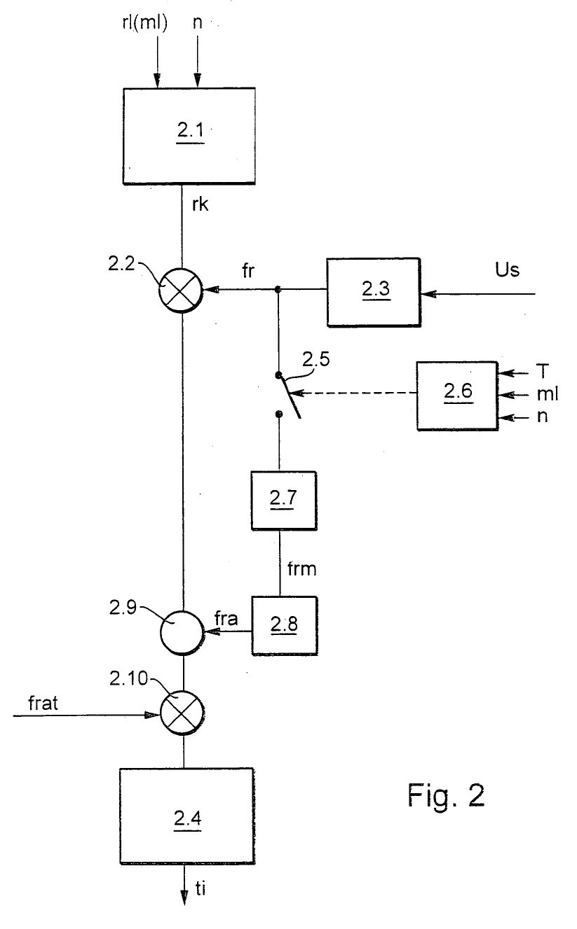

FIG. 2 shows the formation of the fuel-metering signal. Block 2.1 represents a characteristics map, which is addressed by rotational speed n and the relative air charge rl, and in which precontrol values rk for generating the fuel-metering signals are stored. Relative air charge rl is related to a maximum charge of the combustion chamber with air and, to some extent, thus indicates the fraction of the maximum combustion chamber or cylinder charge. It is [essentially] formed from signal ml. The quantity rk corresponds to the fuel quantity associated with air quantity rl.

Block 2.2 shows the [known] multiplicative lambda control adjustment. A mismatch of the fuel quantity to the air quantity is reflected in signal Us of the exhaust-gas probe. A controller 2.3 forms regulated controlled variable fr from this, which reduces the mismatch via adjustment 2.2.

From the signal thus corrected, the metering signal, for instance a control pulse width for the fuel injectors, may already be generated in block 2.4. Block 2.4, therefore, represents the conversion of the relative and corrected fuel quantity into an actual control signal, taking into account the fuel pressure, injector geometry, etc.

Blocks 2.5 through 2.9 represent the [known] mixture adaptation based on operating parameters, which may have a multiplicative and/or an additive effect. Circle 2.9 is meant to represent these three possibilities. Switch 2.5 is opened or closed by [means] arrangement 2.6, operating parameters of the internal combustion engine, such as temperature T, air mass ml and rotational speed n being supplied to [means] arrangement 2.6. [Means] Arrangement 2.6 in conjunction with switch 2.5 thus permits an activation of the three named adaptation possibilities as a function of operating parameter ranges. The formation of adaptive adjustment fra for the fuel-metering signal generation is shown by blocks 2.7 and 2.8. Block 2.7 forms the average value frm of regulating controlled variable fr when switch 2.5 is closed. Deviations of average value frm from neutral value 1 are incorporated by block 2.8 into adaptation adjustment variable fra. For instance, let us say regulating controlled variable fr, due to a mismatch of the precontrol, first goes toward 1.05. Block 2.8 incorporates the 0.05 deviation from value 1 into value fra of the adaptive adjustment. In case of a multiplicative fra adjustment, fra then goes toward 1.05, with the result that fr will go toward 1 again. In this [way] manner, the adaptation ensures that mismatches of the precontrol do not require renewed adjustment at each change of operating points. This adjustment of adaptation quantity fra is [carried out] performed at high temperatures of the internal combustion engine, such as above a cooling water temperature of 70° C., switch 2.5 being then closed. However, once adjusted, fra also has an effect on the formation of the fuel metering signal when switch 2.5 is open.

This [known] adaptation is supplemented, within the framework of the present invention, by a further correction frat, which becomes effective in the linkage 2.10.

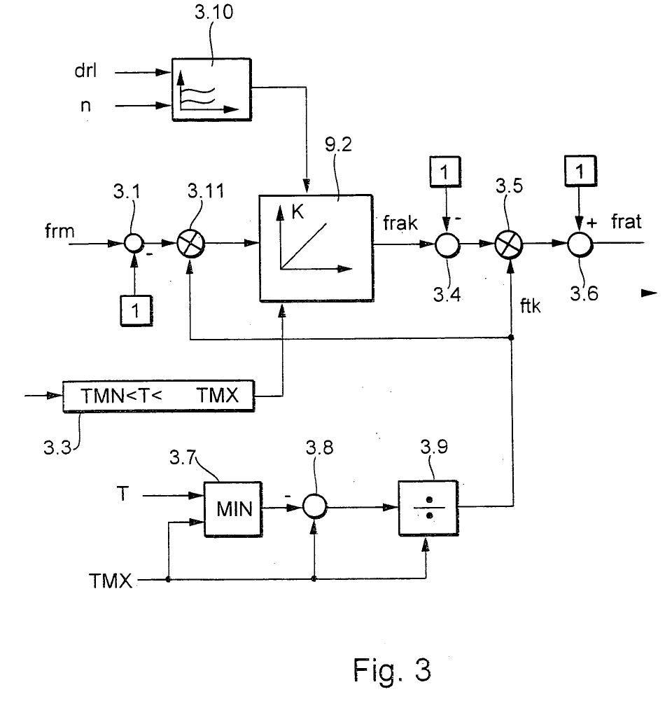

An exemplary embodiment of the frat formation is shown in FIG. 3. Block 3.1 supplies the deviation of the average regulating controlled variable frm from value 1 to an integrator block 3.2 (not shown). Block 3.3 activates the integrator for comparatively low engine temperatures T from an interval TMN<T<TMX. TMN as the lower interval limit may, for instance, be 10-30° C., especially 20° C.; TMX as the upper interval limit may, for instance, correspond to the temperature at which the usual adaptation is activated via the closing of switch 2.5. A typical value for this temperature is 70° C.

The output value of the integrator, using the value frak, supplies a measure for the mismatch in a comparatively cool engine.

[An essential] A feature of the present invention is taking into consideration this value for a cool engine in the formation of the fuel metering signal, without there being yielded, at high temperatures, differences for the [known] adaptation in hot engines.

This is achieved, for example, by blocks 3.4 to 3.6 and 2.10.

The important thing is, first of all, the linkage of the integrator output frak with a temperature-dependent quantity ftk, the linkage having to accomplish the [essential] feature mentioned, of the present invention. In the example, ftk represents a multiplicative correction between zero and one. The value zero [comes about] occurs for a hot engine, i.e. at T>TMX. Then the minimum selection in block 3.7 supplies the value TMX. In block 3.8 the value zero is produced, as the difference between TMX and TMX, which is supplied to the quotient formation in block 3.9 as numerator. Block 3.8 correspondingly supplies the value zero as the magnitude of the temperature dependent quantity ftk. To this value ftk=zero, the value 1 is added in block 3.6. According to this, the sum frat has the value 1, and accordingly it does not change the fuel metering signal formation for a hot engine, in the case of the multiplicative linkage in block 2.10. In other words: For a hot engine, ftk has a maximum weakening effect on frak. Therefore, the quantity frak is not effective at all when the engine is hot, in the extreme case sketched here. When the engine is cool, such as when T=zero ° C., the minimum selection supplies the value zero, and the subsequent quotient formation supplies the value 1. The quantity ftk is then neutral and acts upon frak in a minimally weakening [way] manner. In order to compensate for the addition of the 1 in block 3.6 for this case, there is a subtraction of 1 in block 3.4. For a cool engine (T=zero), ftk=1. In that case, frat_{(ftk=1)}=(frak−1)·ftk+1=frak acts like an unchanged value frak, and thus not weakened, upon the fuel metering signal formation. In other words: The further adaptive correction according to the present invention acts only when the engine is cool. The correction varies continuously between the extreme values described.

Characteristics map 3.10 supplies values K for the integration speed in integrator 3.2 as a function of values for drl and n. The quantity drl is the change of the aspirated air mass, which, for example, in the case of transitional operating conditions is especially large. In this [way] manner, in the transitional operating conditions, the mismatches have an effect on the adaptation only in a weakened form.

What is claimed is:

1. A method for compensating for mismatches of the precontrol of a fuel metering for an internal combustion engine
regulation being superimposed on the precontrol,
and at least one correction quantity being formed, from the behavior of the regulation at high temperatures of the internal combustion engine, which influences the fuel metering even at low temperatures of the internal combustion engine in a supplementing way to the superimposed regulation for compensating for the mismatches,
wherein
at low temperatures a further correction quantity is formed which acts upon the fuel metering,
its effect at low temperatures of the internal combustion engine being greater than at high temperatures of the internal combustion engine.

2. The method as recited in claim 1, wherein for the formation of the further correction quantity (frat), the deviation of an average regulating controlled variable frm from the value 1 is integrated at comparatively low engine temperatures T.

3. The method as recited in claim 2, wherein the integration at engine temperatures T is activated from a temperature interval TMN<T<TMX.

4. The method as recited in claim 3, where TMN as the lower interval limit is 10-30° C., especially 20° C., and TMX as the upper interval limit corresponds to that temperature at which the usual adaptation is activated.

5. The method as recited in claim 4, wherein TMX is approximately 70° C.

6. The method as recited in one of the preceding claims, wherein the one further correction quantity, which acts upon the fuel metering in such a way that the effect at low temperatures of the internal combustion engine is greater than at high temperatures of the internal combustion engine, is changed as a function of the engine temperature in such a way that, at high temperatures, no differences from the known adaptation in the case of hot engines come about.

7. The method as recited in claim 6, wherein the output frak of the integrator is linked to a temperature-dependent quantity ftk in such a way that the result of the linkage becomes smaller with increasing temperature.

8. The method as recited in claim 7, wherein the temperature-dependent quantity ftk forms a multiplicative correction varying between zero and one, the value zero coming about for a hot engine.

9. The method as recited in claim 8, wherein the correction varies continuously between its extreme values.

10. The method as recited in one of the preceding claims, wherein the integration speed is a function of values for load and rotational speed of the engine.

11. An electronic control unit of an internal combustion engine which carries out a method for compensating for mismatches of the precontrol of a fuel metering for an internal combustion engine,
a regulation being superimposed on the precontrol,
and at least one correction quantity being formed, from the behavior of the regulation at high temperatures of the internal combustion engine, which influences the fuel metering even at low temperatures of the internal combustion engine in a supplementing to the superimposed regulation for compensating for the mismatches,
wherein the electronic control unit
forms a further correction variable which acts upon the fuel metering,
its effect at low temperatures of the internal combustion engine being greater than at high temperatures of the internal combustion engine.
